(19) United States
(12) Patent Application Publication
(10) Pub. No.: US 2007/0204533 A1
(43) Pub. Date: Sep. 6, 2007

(54) Wind abatement barrier mounting brackets and kit

(76) Inventor: Ted Gower, N. Palm Beach, FL (US)

Correspondence Address: MCHALE & SLAVIN, P.A., 2855 PGA BLVD, PALM BEACH GARDENS, FL, 33410, US

(21) Appl. No.: 11/366,790

(22) Filed: Mar. 1, 2006

(51) Int. Cl. E06B 3/26

(52) U.S. Cl. 52/202

(57) ABSTRACT

A universal mounting system for a flexible wind abatement barrier includes a flexible textile screen of a size and shape to cover an opening in a building. The shutter has hems at the peripheral edges with thickened structure. Several discrete brackets are fastened to the shutter hems about the margin of any opening with random spacing between the brackets. Each bracket has a mounting plate and a clamp. The thickened hems are threaded through the clamps to secure the shutter.

### FIELD OF THE INVENTION

This invention is directed to the field of protection for structures against high winds, such as hurricanes, and resultant damaging debris and water.

### BACKGROUND OF THE INVENTION

Hurricane protective devices, in rigid form often called shutters, and in fabric form often called flexible wind abatement and impact protective devices, fasten over the frangible area of a building to be protected. These devices are usually custom fitted to the structure, necessarily so due to the varied myriad of differing situations in need of protection. Often bolt holes along each end of the panel must be precisely aligned with mounting holes placed around the area, such as a window, to be protected. Occasionally a continuous track is fastened to the structure to hold the bolts or mounting apparatus. These tracks are usually considered aesthetically ugly. Once the shutter panel is properly aligned, a bolt is placed through the bolt hole to secure the panel over the area. Installation of rigid shutters is labor intensive and requires precise measurements and drilling of many precisely aligned attachment points around the openings to be protected. Installation of the flexible fabric system is less precise and more forgiving, but still requires a labor intensive custom installation.

These mounting bars also must be precisely placed on the building in order for the building anchors, or fasteners, on the individual shutters to line up with each other and the fasteners on the bars.

Standardized testing requiring these protective devices to meet certain standards of strength and integrity has been introduced for various utilizations and locales. In order to qualify for use where testing requirements apply, the strength and integrity characteristics of these protective devices must be sufficient to meet mandated standards. As a result of these standards, many undesirable aspects of the previously known rigid shutters have been acerbated. They have become more cumbersome, more bulky, heavier, more expensive, and more difficult to store.

Due to the problems associated with rigid shutters, a large part of the industry has turned to the flexible wind abatement barriers. Prior art patents that disclose the utilization of fabric or netting material to cover a unit, wherein the fabric are fastened to the ground are illustrated in the following patents: U.S. Pat. No. 3,862,876 issued to Graves, U.S. Pat. No. 4,283,888 and U.S. Pat. No. 4,397,122 issued to Cros, U.S. Pat. No. 4,858,395 issued to McQuirk, U.S. Pat. No. 3,949,527 issued to Double et al., U.S. Pat. No. 3,805,816 issued to Nolte, U.S. Pat. No. 5,522,184 issued to Oviedo-Reyes, U.S. Pat. No. 4,590,714 issued to Walker and U.S. Pat. No. 5,522,184 issued to Pineda. U.S. Pat. No. 5,522,184, for example, provides a netting that fits flush over the roof of a building and uses a complicated anchoring system to tie down the netting.

Typical of known flexible, fabric-employing protection devices is the characteristic of substantial rain and wind-permeability. For example, U.S. Pat. No. 5,579,794, issued to Sporta, discloses a wind-permeable perforate sheet that extend downwardly and outwardly from the top of the object to be protected at an acute angle so as to surround a substantial portion of each of the sides with an inclined wind-permeable planar surface.

U.S. Pat. No. 6,325,085 issued to Gower, the instant inventor, illustrates a barrier similar to the instant invention to be deployed inside a building or over individual windows. U.S. Pat. No. 6,176,050 also issued to Gower teaches the use of the barrier material of this invention deployed over multi-story buildings. U.S. Pat. Nos. 6,865,852, and 6,886,299 both issued to Gower, also show other flexible wind abatement barriers All these latter patents disclose units substantially non-permeable to rain, wind and debris, and are incorporated herein by reference.

Similar to rigid hurricane shutters, flexible barriers must also be mounted to a structure to protect a frangible opening, such as a window, from wind carried debris. Prior art flexible panels included bolt holes passing through the material, or stronger perimeter located, webbing systems that are used for receipt of a mounting bolt. The mounting bolt passing through the bolt hole and securing to a structure located mounting hole. Due to the flexible nature of the material, the mounting holes and bolt holes need not be perfectly aligned as the material remained flexible providing some tolerance. However, even if the material provided tolerances in mounting, a large tolerance made for a loose fitting panel that is not aesthetically pleasing when installed.

Flexible hurricane panels, such as those developed by Gower, may employ the use of flexible straps to allow offset adjustment and alignment. Flexible straps allow the installer to tension the material to engage even remote mounting holes, but also correct for misaligned mounting holes. However, if the mounting hole is misaligned by an extensive distance, the flexible straps can bind during tensioning.

Due to various problems, including the danger of physical injury associated with rigid panels, customers that have tired, or become physically unable, to install and remove rigid panels have expressed a desire to convert to the lightweight flexible wind abatement barriers. However, before hereto, switching from rigid panels to flexible wind abatement barriers required custom panels if the mounting holes used for installation of the rigid panels are to be reused. While, standard flexible wind abatement barriers formed into panels could be used to save money, the cost in removing of the older mounting holes could be expensive. Holes placed in stucco require proper filling and repainting to restore the finish. Wood exterior holes required wood rework. When rigid panels are attached to a metal building, metal frame, or the like mounting hardware, the removal of existing mounting bolt holes may not be possible.

What is lacking in the art is a system that allows for automatic alignment of flexible panels, and provides a means for replacing rigid panels with standard size flexible panels.

### SUMMARY OF THE INVENTION

Accordingly, it is an objective of the instant invention to provide a universal mounting system for attaching flexible window and door screens to buildings for protection of the interior from high winds, rain, and debris. The universal mounting system of this invention includes several discrete brackets that are installed about an opening without the necessity of maintaining a precise spatial relationship between each of the brackets.

It is a further objective of the instant invention to provide a mounting system of the instant invention including building fasteners and flexible straps that cooperate with the flexible screen to form a self-centering universal connection.

It is yet another objective to provide an attachment system that allows an adjustable length rope to be attached to the clamping device which spreads the load across the barrier rather than a point load as a rope would ordinarily give, possibly in conjunction with a jam cleat to be used instead of webbing.

It is yet another objective of the instant invention to provide building fasteners in the form of brackets for gripping the flexible material of the shutters.

It is a still further objective of the invention to provide an edge structure of the textile screen material that forms a retainer that cooperates with the brackets.

Disclosed is a flexible wind abatement textile screen which is provided as wind abatement barrier kit for covering any opening in a building. The kit includes the use of a plurality of C-shaped opening brackets and at least one textile screen of a size and shape to cover an opening. The C-shaped brackets operate as a clamp that attaches to a formed hem in the textile screen and includes a fastening means to secure the bracket to a structure. Preferably, the textile screen has at least two opposite peripheral edges each having a hem with an enlarged thickness. The C-shaped clamp is adapted to be slidably connected to the hem whereby said brackets are adapted to be installed near two opposite sides of any opening and said hem of said opposite edges of said textile screen are slidably disposed in said brackets to cover any opening with a hurricane shutter. The hem may include a batten that is segmented to allow for rolling of the material into a bundle for purposes of transportation and storage. One edge of the textile screen webbing employs a strap with buckle adjustment allowing for securement to remotely located or otherwise misaligned mounting bolts.

As a corollary arising from this connection, the webbing and buckle adjustment method can be replaced with a more economical rope, easier to fabricate and for the user to adjust. The point load of a rope is spread by the connector. An additional corollary arising from this invention is the use of a non-continuous, structure mounted track. Prior hereto, the use of a track that was longer than one section required each adjoining section to be precisely butted to the next, often a time consuming and sometimes very difficult task. By leaving an end gap of several inches or more as appropriate, the otherwise captured hem structure will bend to easily continue from one section to the next, while continuing to hold tightly against the structure.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 shows a perspective of the shutter of this invention installed on a building;

FIG. 2 is a cross section of a top loading bracket of this invention;

FIG. 2A is a cross section of a side loading bracket of this invention;

FIG. 2B is a cross section of an end loading bracket of this invention;

FIG. 3 is a cross section of the screen and batten of this invention;

FIG. 4 is a front plan view of a slotted bracket of this invention;

FIG. 4A is a front plan view of an eye-bolt slotted bracket of this invention;

FIG. 4B is a front plan view of a aperture slot with attachment line of this invention;

FIG. 4C is a front plan view of a aperture slot bracket of this invention with a locking plate;

FIG. 4D is a front plan view of a locking plate; and

FIG. 5 is a perspective of another embodiment of this invention;

FIG. 6 is a pictorial view of a wind abatement assembly embodiment illustrates a batten removed from wind abatement material and mounting track;

FIG. 7A is a pictorial illustrating the foldability of the wind abatement material with the batten removed;

FIG. 7B is a pictorial illustrating the rollability of the wind abatement material with the batten;

FIG. 8 is an end view of a mounting base having a substantially rectangular base;

FIG. 8A is a side view of FIG. 8; and

FIG. 9 is a perspective view of a track for receipt wind abatement assembly of FIG. 6.

### DETAILED DESCRIPTION OF THE PREFERRED EMBODIMENT

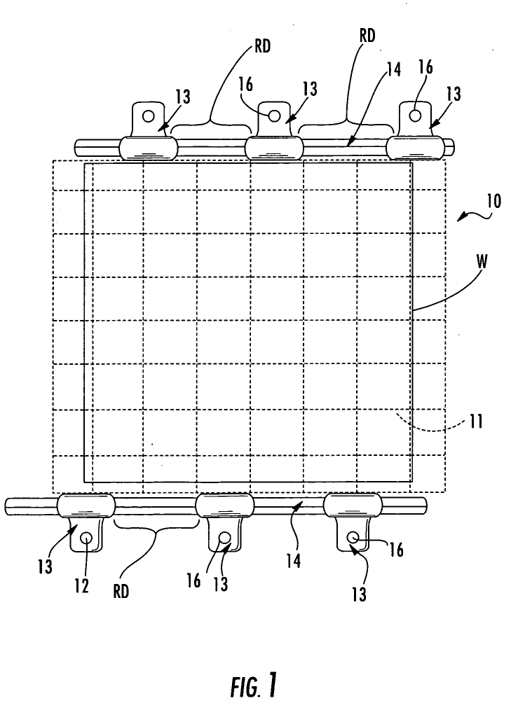

The universal flexible wind abatement barrier mounting system 10, shown in FIG. 1, includes a simplified and less cumbersome interface between the building and the hurricane shutters, as well as, a flexible wind abatement barrier referred to herein as a textile screen 11 includes hems 14 cooperating with the interface to secure the shutters in place on the building. As shown in FIG. 1, the main feature of the mounting system is that the brackets 13 of the interface may have a random distance, RD, between them and do not have to have a uniform spatial relationship with each other. This is a function of the construction of the brackets 13 and the flexibility of the screen material 11 and the hems 14. The flexibility of the material permits the tension force created by the brackets 13 to be perpendicular to the hems to which the brackets are attached.

The material 11 of the flexible wind abatement barriers may be knitted, woven or extruded material, if the material itself meets the criteria described later herein. The device provides a barrier that is substantially impermeable to rain and wind. Although air travels through the barrier, the barrier is approximately 95% closed, and the velocity of wind passing through the device is greatly reduced. For example, the velocity of a 100 mph wind is reduced by approximately 97% by passing through the wind abatement system of the present invention. The wind abatement system of the present invention substantially reduces the force of wind passing through the device and also provides a barrier against wind-borne missiles having diameters of approximately 3/16 inch in diameter or larger. Also, rain drops striking the barrier are reduced in velocity and dispersed into a mist which reduces the water damage to the structure. With higher rains, the water creates a barrier within the barrier resulting in further reduction of wind and rain from passing through the material.

To assure long life, the material 11 preferably would be resistant to the ultra violet radiation, and to biological and chemical degradation such as are ordinarily found outdoors. This invention contemplates either coating the material or utilizing material with inherent resistance to withstand these elements. A synthetic material such as polypropylene has been found to be acceptable. Another example is a coated material of vinyl coated polyester. The fabrics may use natural or synthetic fibers and blends of fibers or blends of yarns, e.g., an open weave with steel reinforcing strands therethrough or Kevlar or other, so-called, ballistic yarns. Materials intended to be used outdoors in trampolines, for example, are more likely candidates for use in this invention. Black colored polypropylene is most resistant to degradation from ultra violet radiation although other colors and vinyl coated polyester may be of sufficient resistant, particularity if the barrier is not stored in direct sunlight when not in use.

In a preferred embodiment, the flexible screen 11 allows air passage through it, albeit at substantially reduced rate. Upwind pressure of 1″ of mercury, which roughly translates into a 100 mph wind, forces air through at 250 cfm or approximately 3 mph. The amount of air passage depends on the interstice size. If a weather tight and transparent barrier is desired, the polypropylene material may be laminated with a flexible clear plastic skin.

Typically, the current impact test of certain locales requires a wood 2×4 stud be shot at the barrier exerting a total force of approximately 230 pounds, or 61.3 psi, over its frontal (impacting) surface. This impact and resultant force relate to the Mullen Burst test commonly used by manufacturers to measure the bursting strength of their fabrics. Thus the impact test heretofore used on rigid devices will work equally well on this flexible material.

The preferred embodiment of this invention would use a textile of the type typically used in trampolines which would burst at 675 psi or a total of 2,531.25 pounds over the same 3.75 square inch frontal surface of the nominal 2×4 test missile and would stretch characteristics of the material are known.

A suitable material is polypropylene formed in a monofilament and woven into geotextile (style 20458) manufactured by Synthetic Industries of Gainesville, Ga. The fabric is woven in a basket (plain) weave as in the preferred embodiment in interstices are substantially equal to 0.6 millimeters which approximates the interstices of commercially available residential window screening.

As shown in FIG. 3, the peripheral edges of the material 11 has hems 14, at least in the edges that will be disposed on opposite sides of the opening in the building. Normally, the hems 14 may be oriented with one hem above the opening and another below the opening, as shown in FIG. 1, but there may be occasions when the brackets of the interface are mounted on opposite lateral sides of the opening. The material 11 may also have the hems 14 with enlarged thickness in all peripheral edges. The enlarged thickness may result from the material being rolled or doubled back on itself. As shown in FIG. 3, the peripheral edge of the material is rolled on itself and secured by sewing, adhesives or heat and pressure to form a tube 21. A plastic batten 20 may be inserted into the tube for added strength and to maintain the shape of the hem while in the bracket 13. The batten 20 may be attached to the hem or it may be separable. The batten may be of any suitable composition including wood, polymer, or metal.

The batten 20 may be sectional, or include the use of thinner sections to allow the batten to be rolled along with the remainder of the flexible screen. By way of example, a rigid batten that is placed around all the edges of a square window frame covering, could not be rolled into a compact storage position. By use of segmented or distance thinning of the batten, the window frame could be rolled tightly. The batten does not have to be continuous as it offers no rigidity to the material but rather its function is to prevent sideward removal of the window material from the C-channel bracket. The C-channel design is for end insertion and removal only.

Further, the hems 14 and battens 20 spreads the tension forces in the hems evenly across the RD between the brackets 13. Because the hems 14 distribute the forces between brackets and opposite sides of the shutter, the brackets do not necessarily have to be aligned across the material.

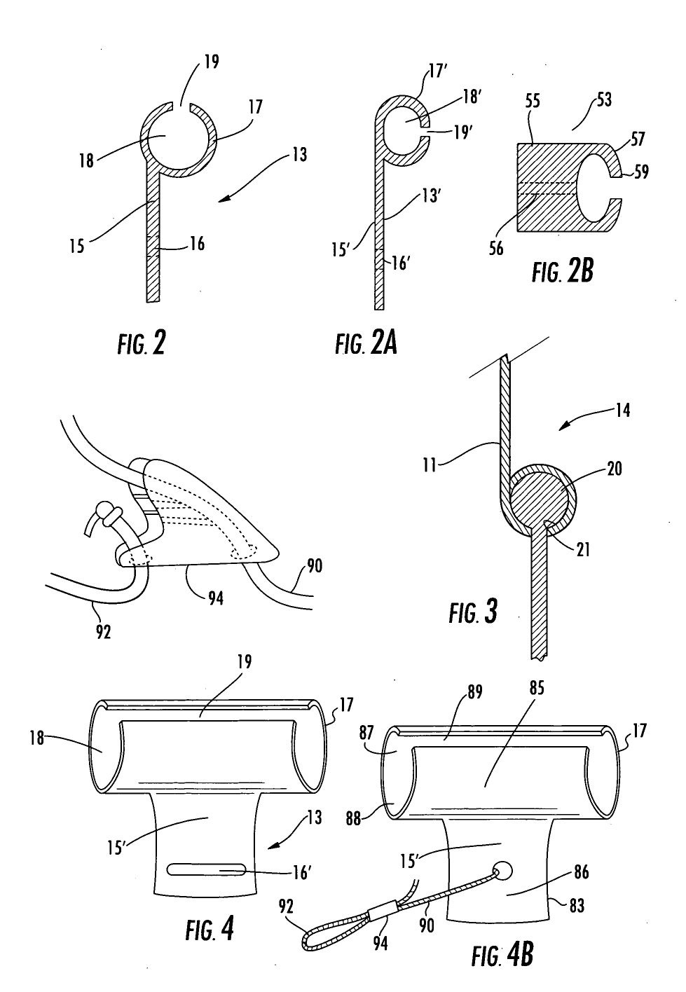

The bracket 13, shown in FIG. 2, has a mounting plate 15 with an aperture 16 therethrough. A clamp 17 is permanently attached on one end of the mounting plate. As shown, the clamp 17 is a C-shaped clamp, preferably of a resilient polymeric or metal material, formed from tubular stock with a slot 19 in the sidewall. The slot 19 is oriented transverse to the longitudinal axis of the mounting plate 15. The tubular section inherently provides a living hinge biasing the jaws of the clamp to close the slot 19.

The mounting plate 15 is placed against the building with the clamp 17 near the margin of any opening W and the slot 19 approximately parallel with the margin of the opening. A mounting bolt 12 is driven through the aperture 16 into the building to attach the bracket to the building, as shown in FIG. 1. The hems 14 on opposite peripheral edges of the flexible shutter are threaded through the clamps on opposite sides of the opening to install the shutters. Rather than using mounting bolts, threaded studs may be placed in the building an a nut may be used to hold the mounting plate to the stud.

FIG. 2A is nearly identical to FIG. 2 depicting an alternative embodiment by use of bracket 13′ having a mounting plate 15′ with an aperture 16′ therethrough. A clamp 17′ is permanently attached on one end of the mounting plate. As shown, the clamp 17′ is a C-shaped clamp, preferably of a resilient polymeric or metal material, formed from tubular stock with a slot 19′ in the sidewall facing outwardly. The slot 19′ is oriented transverse to the longitudinal axis of the mounting plate 15′ and by facing outwardly provides an additional frictional engagement. The tubular section inherently provides a living hinge biasing the jaws of the clamp to close the slot 19′.

In this embodiment, the mounting plate 15′ is placed against the building with the clamp 17′ near the margin of any opening W and the slot 19′ juxtapositioned to the opening. A mounting bolt is driven through the aperture 16′ into the building to attach the bracket to the building, as shown in FIG. 1. The hems 14′ on opposite peripheral edges of the flexible shutter are threaded through the clamps on opposite sides of the opening to install the shutters. Rather than using mounting bolts, threaded studs may be placed in the building an a nut may be used to hold the mounting plate to the stud.

FIG. 2B depicts the side view of still another embodiment by use a bracket 53 embodiment having a having a mounting base 55 with an aperture 56 therethrough. A clamp 57 is permanently attached on one end of the mounting base. As shown, the clamp 57 is a C-shaped clamp, preferably of a resilient polymeric or metal material, formed from tubular stock with a slot 59 in the sidewall. The slot 59 is oriented transverse to the longitudinal axis of the mounting plate 55 and by facing outwardly provides an additional frictional engagement. The tubular section inherently provides a living hinge biasing the jaws of the clamp to close the slot 59.

In this embodiment, the mounting base 55 is placed against the building and mounted to an existing building anchor or directly to a building structure by use of a fastener, such as a Tapcon, placed through the mounting hole 56.

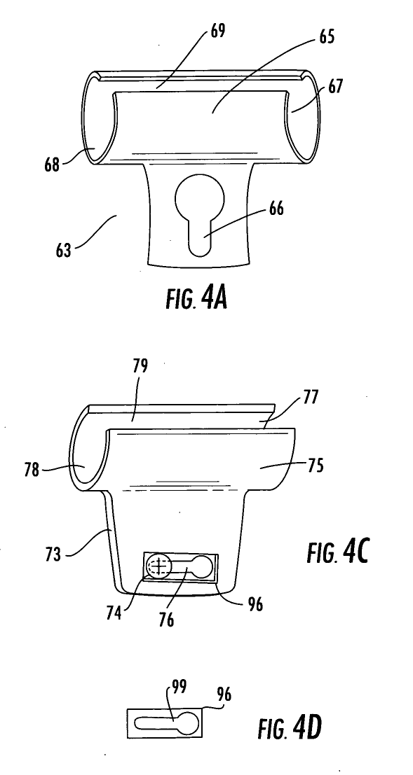

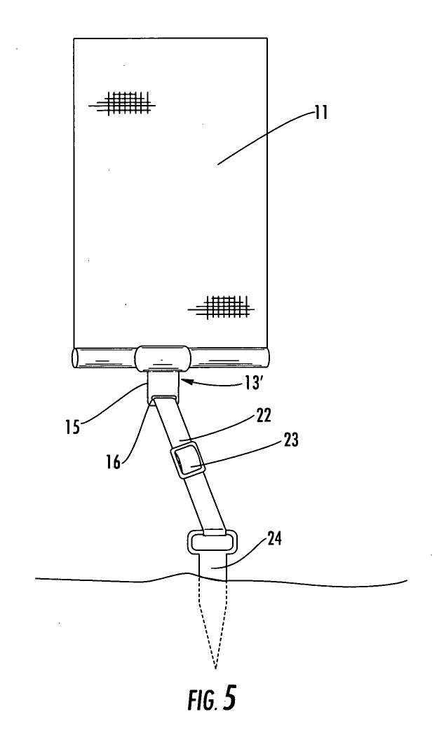

The bracket 13 of the first embodiment shown is FIG. 2, is further shown in FIG. 4 and FIG. 5, and may be used in situations where a bracket cannot be placed on one side of an opening and anchor 24 is placed in the ground or other support surface. The strap 22 is connected through the aperture 16 and attached to the anchor. In applying tension between the bracket and the anchor, the strap may be shortened by buckle 23. The aperture 16 is shown with an elongated shape so that the anchor 24 may be laterally displaced from the bracket position but will not bind the strap 22 during adjustment. In this illustration, the bracket 13 may be slid along the hem 14 allow for proper alignment between the anchor 24 and the bracket slot 16. As shown in FIG. 4, the slot 16 may be curved but is preferably flat, as shown, allowing for the receipt of a flat strap.

The bracket, as shown in FIG. 4A, may include an eye-bolt aperture 66 formed in the bracket 63 allowing attachment to bolts protruding from a structure. The eye-bolt bracket 63 is preferably used in hanging the wind abatement barrier over an opening, such as a window. As with the earlier embodiments, the bracket 63 includes a mounting base 65 with the eye-bolt aperture 66 extending through the mounting base. Clamp 67 is permanently attached on one end of the mounting base. As shown, the clamp 67 is a C-shaped clamp, preferably of a resilient polymeric or metal material, formed from tubular stock with a slot 69 in the sidewall. The slot 69 is oriented transverse to the longitudinal axis of the mounting plate 65. The tubular section inherently provides a living hinge biasing the jaws of the clamp to close the slot 69.

FIG. 4B depicts yet another embodiment of the mounting bracket 83. In this embodiment, aperture 86 is sized to receive an attachment line, such as a rope 90. The attachment line 90 having a distal end 92 available for coupling to a fixed element and the distance of the line made adjustable by use of a flying jam cleat. The use of line, such as rope, is more economical than a web strap and eliminates the offset crimping problems found with strap buckles. The flying jam cleat allows ease in tightening and can be arranged to self tighten upon movement of the barrier during a wind storm. The aperture 86 is placed in the mounting base 85 with clamp 87 is permanently attached on one end of the mounting base. As shown, the clamp 87 is a C-shaped clamp, preferably of a resilient polymeric or metal material, formed from tubular stock with a slot 89 in the sidewall. The slot 89 is oriented transverse to the longitudinal axis of the mounting plate 85. The tubular section inherently provides a living hinge biasing the jaws of the clamp to close the slot 89.

FIGS. 4C & 4D depicts yet another embodiment of the mounting bracket 73. In this embodiment, aperture 76 is sized to receive a fastener 74 having a head that engages the mounting base 75 with clamp 77 permanently attached on one end of the mounting base for securement to a building anchor, not shown. A building anchor may include an existing threaded hole that was used for rigid shutters, ground mounted anchors included thread screws. As shown, the clamp 77 is a C-shaped clamp, preferably of a resilient polymeric or metal material, formed from tubular stock with a slot 79 in the sidewall. The slot 79 is oriented transverse to the longitudinal axis of the mounting plate 75. The tubular section inherently provides a living hinge biasing the jaws of the clamp to close the slot 79. Locking plate 96 has a eye hole 99 that is positioned over the aperture 76 and beneath the fastener 74. Sliding of the locking plate 96 secures the bracket 93 to the building anchor by use of a fastener.

The flexible wind abatement barrier and universal mounting system 10 can be supplied as a kit. The kit is made up of several pre-cut and hemmed flexible wind abatement barriers, selected from stock items. Included in the kit are several brackets for attachment to a building and battens for insertion in the hems. Several straps may also be included, if desired. The kit may or may not have several threaded mounting studs or mounting bolts.

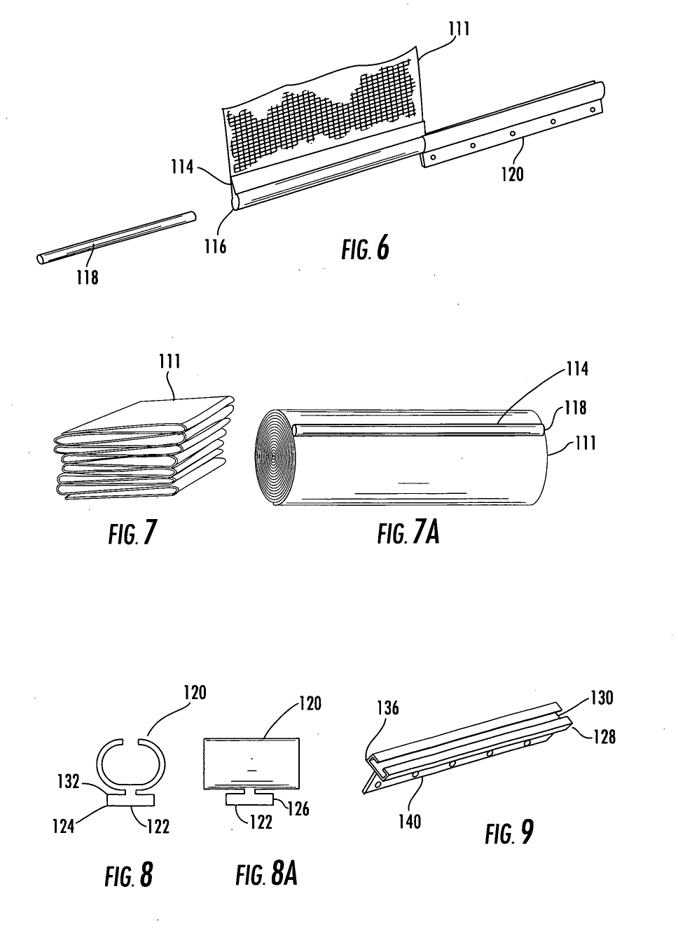

Set forth in FIG. 6 is another embodiment of a mounting system for the flexible wind abatement barrier. In this embodiment, a flexible wind abatement barrier referred to herein as a textile screen 111 an overlap of material 114 that cooperates with the main portion of the screen to form a aperture 116. The material 111 of the flexible wind abatement barriers may be knitted, woven or extruded material, if the material itself meets the criteria previously described.

The peripheral edges of the material are secured by sewing, adhesives or heat and pressure to form the aperture wherein a batten 118 may be inserted into the aperture 116 to maintain the shape of the aperture. The batten 118 may be attached inserted into the aperture 116 before placement within a track 120, or preferably the edge of the textile is placed within the track 120 and the batten then inserted into the aperture now withing the track. The track can be of any shape, such as described herein, which is commonly referred to as C-shape track. The batten may be of any suitable composition including wood, polymer, or metal.

In this embodiment, the batten can be elongated allowing for ease of insertion. Further, the type of installation allows for the cutting of batten to length allowing the material to be shipped in a compact arrangement.

Shown in FIG. 7 is the textile 111 in a folded position for shipping and storage purposes. Alternatively, the textile 111 can be rolled in the conventional manner wherein the batten 118 is left within the aperture 116. As previously mentioned, the batten 118 may be sectional, or include the use of thinner sections to allow the batten to be rolled along with the remainder of the flexible screen. By way of example, a rigid batten that is placed around all the edges of a square window frame covering, could not be rolled into a compact storage position. By use of segmented or distance thinning, or removal battens, the window frame could be rolled tightly. The batten does not have to be continuous as it offers no rigidity to the material but rather its function is to prevent sideward removal of the window material from the C-channel bracket. The C-channel design is for end insertion and removal only.

The battens 118 spreads the tension forces in the hems evenly across the track, because the battens distribute the forces between tracks, the tracks do not necessarily have to be aligned across the material.

A removable C-shaped bracket 120, shown in FIG. 8, has a mounting plate 122 that has a side wall 124 and end wall 126. This type of bracket allows for placement within a track 128 having an enlarged opening 130 which permits placement of the C-shaped bracket along end walls 126 and, upon a 90 degree rotation, causes the upper wall 132 to engage the enlarged opening to maintain the track therein. It should be noted that the mounting plate 122 may be substantially square wherein the mounting plate must be inserted into the track 128 at an end 136 of the enlarged opening 130. The track may be mounted to a wall with fasteners, not shown, along the flange 140.

This mounting plate 122 can be used with most any type of bracket including a living hinge as previously described for biasing the jaws of the clamp to close.

It is to be understood that while a certain form of the invention is illustrated, it is not to be limited to the specific form or arrangement herein described and shown. It will be apparent to those skilled in the art that various changes may be made without departing from the scope of the invention.

What is claimed is:

1. A mounting system for flexible wind abatement barriers comprising a plurality of brackets for attachment to the peripheral edges of a textile screen, said textile screen sized and shaped to cover at least a portion of a building, each of said brackets having a clamp adapted to slide along an edge of said textile screen allowing alignment of said bracket to a building anchor, and a means for securing said bracket to said building anchor.

2. A mounting system for flexible wind abatement barriers of claim 1 wherein said means for securing comprises an aperture of a size and shape to cooperate with one of a group consisting of bolts, nails, pins, cables, lines, ropes or straps.

3. A mounting system for flexible wind abatement barriers of claim 1 wherein said clamp has a C-shape receptive to a textile screen having a beaded edge, said C-shape allowing for the slidable movement of said claim along said beaded edge.

4. A mounting system for flexible wind abatement barriers of claim 1 wherein said clamp has separable jaws joined by a living hinge biasing said jaws closed, said living hinge disposed transversely to said mounting plate.

5. A mounting system for flexible wind abatement barriers of claim 1 wherein said mounting plate has a longitudinal axis and said clamp has an axis parallel to said longitudinal axis, said mounting plate longitudinal axis and said parallel clamp axis being offset whereby said clamp is displaced toward one side of said mounting plate.

6. A mounting system for flexible wind abatement barriers of claim 1 wherein said peripheral edges of said textile screen are constructed with a hem having an enlarged thickness, said hem adapted to be restrained in said clamp.

7. A mounting system for flexible wind abatement barriers of claim 6 wherein said hem of said textile screen has an elongated pocket with a batten disposed in said pocket.

8. A mounting system for flexible wind abatement barriers of claim 7 wherein said batten is segmented to allow for rolling of said textile screen for transportation and storage.

9. A wind abatement barrier kit for covering at least a portion of a building comprising a plurality of discrete brackets, at least one textile screen of a size and shape to cover said portion of a building, said brackets each having a clamp attached to a mounting plate, said mounting plate having a fastening means to secure said bracket relative to any opening, said textile screen having at least two opposite peripheral edges, said peripheral edges each having a hem with an enlarged thickness, said clamps adapted to be slidably connected to said hem allowing for alignment of said mounting plate to a building anchor.

10. A wind abatement barrier kit for covering an opening in a building of claim 9 wherein said plurality of discrete brackets on each side of said opening are spaced apart a random distance and said first random distance is not related to a second random distance between said discrete brackets on the other side of the opening.

11. A wind abatement barrier kit for covering an opening in a building of claim 9 wherein said kit includes a plurality of bolts, said bolts cooperating with said fastening means to secure the brackets to a building.

12. A wind abatement barrier kit for covering an opening in a building of claim 10 wherein said kit includes at least one strap adapted to attach to said clamps, said fastening means in said mounting plate having a slot, said slot adapted to self-center said strap to secure said bracket.

13. A wind abatement barrier kit for covering an opening in a building of claim 10 wherein said kit includes at least one line adapted to attach to a clamp, with a distal end of said line secured to a building anchor.

14. A wind abatement barrier kit for covering an opening in a building of claim 13 wherein said line includes a flying jam cleat providing adjustment between said mounting plate and said building anchor.

15. A wind abatement barrier kit according to claim 9 wherein a batten is placed in said hem for said enlarged thickness.

16. A wind abatement barrier kit according to claim 15 wherein said batten is segmented to allow for rolling of said material for storage.

17. A wind abatement barrier kit according to claim 9 wherein said bracket is secured to a building anchor by a locking plate.

18. A wind abatement barrier kit according to claim 9 wherein said bracket is secured to a building anchor by a web strap.

19. A wind abatement barrier kit according to claim 18 wherein said web strap includes a buckle to allow for adjustment between said bracket and said building anchor.

20. A wind abatement barrier kit for covering at least a portion of a building comprising a plurality of brackets, at least one textile screen of a size and shape to cover said portion of a building, said brackets each having a clamp attached to a mounting plate, said mounting plate having a fastening means to secure said bracket relative to any opening, said textile screen having at least two opposite peripheral edges, said peripheral edges each having an aperture formed thereon for receipt of a removable batten.
